(19) United States
(12) Patent Application Publication
(10) Pub. No.: US 2018/0106346 A1
(43) Pub. Date: Apr. 19, 2018

(54) BELT TENSION CONTROL SYSTEM AND METHOD

(71) Applicant: Deere and Company, Moline, IL (US)

(72) Inventor: Pedro Gonzalez-Mohino, Madrid (ES)

(21) Appl. No.: 15/294,587

(22) Filed: Oct. 14, 2016

(51) Int. Cl. F16H 7/12; F16H 7/02

(52) U.S. Cl. CPC F16H 7/1263; F16H 2007/0812; F16H 7/1281; F16H 7/02

(57) ABSTRACT

A belt tension control system may include a first belt engager to engage a first portion of a belt extending between and on a first side of first and second pulleys and a second belt engager to engage a second portion of the belt extending between and on a second side of the first and second pulleys. The first belt engager is movably supported so as to move in response to changes in tension of the first portion of the belt. The second belt engager is movably supported so as to move in response to changes in tension of the second portion of the belt. The first belt engager and the second belt engager are connected by a linkage such that movement of the first belt engager towards the first portion of the belt automatically retracts the second belt engager away from the second portion of the belt, wherein the linkage automatically maintains a constant ratio of belt tension of the first portion to belt tension of the second portion.

### BACKGROUND

Endless belts are commonly used to transmit power from an engine or motor. Over time, such belts are subject to wear.

### BRIEF DESCRIPTION OF THE DRAWINGS

FIG. 1 is a schematic diagram of an example belt tension control system.

FIG. 2 is a flow diagram of an example method for controlling belt tension to reduce belt wear.

FIG. 3 is a schematic diagram of an example belt tension control system.

FIG. 4 is a schematic diagram of an example belt tension control system.

FIG. 5 is a schematic diagram of an example belt tension control system.

### DETAILED DESCRIPTION OF EXAMPLES

Endless belts are commonly used to transmit power from an engine or motor. Over time, such belts are subject to wear. Disclosed herein are example systems and an example method for reducing wear of the belt by maintaining different portions of the belt at a predetermined tension ratio. The systems and methods disclosed herein utilize a mechanical or fluid linkage that transmits motion from one belt engager to another belt engager so as to maintain a predetermined tension ratio. As a result, the systems and the methods provide a relatively simple and low cost solution to reducing belt wear.

Disclosed herein is an example belt tension control system that comprises a first belt engager to engage a first portion of a belt extending between and on a first side of first and second pulleys and a second belt engager to engage a second portion of the belt extending between and on a second side of the first and second pulleys. The first belt engager is movably supported so as to move in response to changes in tension of the first portion of the belt. The second belt engager is movably supported so as to move in response to changes in tension of the second portion of the belt. The first belt engager and the second belt engager are connected by a linkage such that movement of the first belt engager towards the first portion of the belt automatically retracts the second belt engager away from the second portion of the belt, wherein the linkage automatically maintains a constant ratio of belt tension of the first portion to belt tension of the second portion.

Disclosed herein is an example belt tension control system that comprises a first fluid cylinder, a first piston slidably disposed within the first fluid cylinder and extending from a first side of the first fluid cylinder, a first belt engager connected to the first piston and to engage a first portion of a belt extending between and on a first side of first and second pulleys, a second fluid cylinder, a second piston slidably disposed within the second fluid cylinder and extending from a first side of the second fluid cylinder, a second belt engager connected to the second piston and to engage a second portion of a belt extending between and on a second side of the first and second pulleys and a fluid line connecting a second side of the first fluid cylinder to a second side of the second fluid cylinder. The second sides of the first fluid cylinder and the second fluid cylinder are connected such that the first portion of the belt and the second portion of the belt are automatically maintained at a constant tension ratio.

Disclosed herein is an example method for reducing wear of a belt. The method comprises engaging a first portion of an endless belt wrapped about first and second pulleys with a first belt engager, engaging a second portion of an endless belt wrapped about the first and second pulleys with a second belt engager operably linked to the first belt engager and transmitting motion of the first belt engager to the second belt engager such that movement of the first belt engager away from the first portion of the belt automatically moves the second belt engager towards the second portion of the belt to maintain a constant ratio of belt tension of the first portion to belt tension of the second portion.

FIG. 1 schematically illustrates an example belt tension control system 20. Belt tension control system 20 maintains a substantially constant ratio of tensions on opposite sides/segments of the pulley belt to reduce wear of the belt. Belt tension control system 20 comprises belt engager 30, belt engager 32 and linkage 34. Belt engager 30 comprises a member to physically contact and engage a first segment or portion 38 of an endless belt 40 wrapping about a driven pulley 42, rotatably driven in a counter clockwise direction, and a driver or drive pulley 44 driving belt 40 in a counterclockwise direction. Belt engager 30 is movable towards and away from portion 38 to facilitate adjustment of the tension of portion 38 of belt 40. In one implementation, belt engager 30 is linearly movable towards and away from portion 38. In another implementation, belt engager 30 moves in an arc or pivots about an axis towards and away from portion 38 of belt 40. In one implementation, belt engager 30 may comprise a roller or pulley. In other implementations, belt engager 30 may comprise other rotating or stationary structures that bear against portion 38 to control the tension of portion 38 of belt 40.

Belt engager 32 comprises a member to physically contact and engage a second segment or portion 48 of the endless belt 40. Belt engager 30 is movable towards and away from portion 38 to facilitate adjustment of the tension of portion 38 of belt 40. In one implementation, belt engager 30 is linearly movable towards and away from portion 38. In another implementation, belt engager 30 moves in an arc or pivots about an axis towards and away from portion 38 of belt 40. In one implementation, belt engager 32 may comprise a roller or pulley. In other implementations, belt engager 32 may comprise other rotating or stationary structures that bear against portion 48 to control the tension of portion 48 of belt 40.

Linkage 34 connects belt engager 30 two belt engager 32 such that motion of one of belt engagers 30, 32 is transferred to the other of belt engager 30, 32. As a result, movement of one of belt engager 30, 32 towards its respective portion 38, 48 automatically results in the other of belt engagers 30, 32 being moved away from or retracted from its respective portion 38, 48. Likewise, movement of one of belt engager 30, 32 away from its respective portion 38, 48 automatically results in the other of belt engager's 30, 32 being moved towards its respective portion 38, 48.

Linkage 34 is configured so as to maintain a constant ratio of the belt tension T2 of portion 48 with respect to belt tension T1 of portion 38. For purposes of this disclosure, the phrase “configured to” denotes an actual state of configuration that fundamentally ties the stated function/use to the physical characteristics of the feature proceeding the phrase “configured to”. In the example illustrated, portion 48 of belt 40 is the load or working portion of belt 40, the portion of belt 40 being pulled by the drive pulley 44. Portion 38 of belt 40 is the backside of the belt 40 which is maintained at a tension T1 to main sufficient frictional contact in coupling of belt 40 against pulleys 42 and 44. In one implementation, linkage 34 maintains a constant ratio T2/T1 of at least 4 and no greater than 6. In one implementation, linkage 34 maintains a constant ratio T2/T1 of 5. By maintaining such a constant ratio T2/T1, wear of the belt is reduced.

In one implementation, linkage 34 comprises a mechanical linkage provided by one or more of a series of springs, cams, links or bars, gears, sprockets, chains and cables. For example, in one implementation, link 34 may comprise a Bowden cable having a first end operably coupled to belt engager 30 and a second end operably coupled to belt engager 32, wherein the internal cable of the Bowden cable, retained within an outer sheath, slides to transmit motion from one of belt engager 30, 32 to the other of belt engager 30, 32.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members. The term “fluidly coupled” shall mean that two or more fluid transmitting volumes are connected directly to one another or are connected to one another by intermediate volumes or spaces such that fluid may flow from one volume into the other volume.

In yet another station, linkage 34 may comprise a fluid linkage that transmits motion or movement of one of belt engager 30, 32 to the other of belt engager 30, 32. In one implementation, such a fluid linkage 34 may comprise piston-cylinder assemblies having pistons connected to each of the belt engager 30, 32 and a fluid line connecting the piston-cylinder assemblies. For example, such a fluid linkage 34 may comprise a hydraulic or pneumatic line interconnecting a first piston-cylinder assembly having a piston connected to belt engager 30 and a second piston-cylinder assembly having a piston connected to belt engager 32. In such an implementation, the configuration of the individual cylinder-piston assemblies facilitates the provision of the maintaining of the constant tension ratio T2/T1.

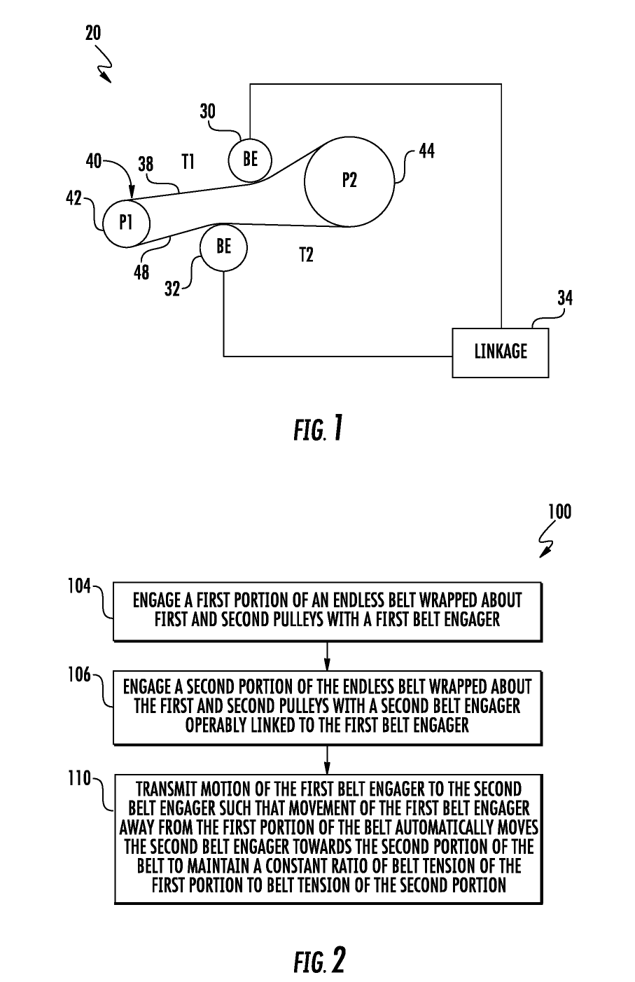

FIG. 2 is a flow diagram of an example method 100 for reducing belt wear by controlling belt tension. Although method 100 is described as being carried out in the context of belt tension control system 20 of FIG. 1, it should be appreciated that method 100 may be carried out by any of the example belt tension control systems described hereafter or other belt tension control systems having similar characteristics.

As indicated by block 104, belt engager 30 engages a first portion 38 of an endless belt 40 is wrapped about first and second pulleys 42 and 44. As indicated by block 106, belt engager 32 engages a second portion 48 of the endless belt 40 which is also wrapped about the first and second pulleys 42 and 44. The second belt engager 32 is operably linked, by linkage 34, to the first belt engager 30. As indicated above, such operably linking may be facilitated by a mechanical linkage or a fluid linkage.

As indicated by block 110, motion or movement of belt engager 30 is automatically transmitted, in a predetermined proportional manner, to belt engager 32 by linkage 34. As a result, movement of belt engager 30 away from portion 38 of belt 40 automatically moves belt engager 32 towards portion 48 of belt 40 so as to maintain a constant ratio of the belt tension of the first portion 38 to the belt tension of the second portion 48. Likewise, movement of belt engager 30 towards portion 38 of belt 40 automatically moves belt engager 32 away from portion 48 of belt 40 so as to maintain a constant ratio of the belt tension of the first portion 38 to the belt tension of the second portion 48. In one implementation, motion is transmitted in a proportional manner such that the belt tension T2 of the second portion 48 to the belt tension T1 of the first portion 38 has a ratio of T2/T1 of at least 4 and less than or equal to 6, nominally 5. The veritable tensioning provided by method 100 maintained such a constant tension ratio T2/T1 to reduce wear of belt over time. When the belt is not running, such as during winter storage, such tension is reduced or eliminated.

FIG. 3 schematically illustrates belt tension control system 220, an example implementation of belt tension control system 20 described above. Belt tension control system 220 is similar to system 20 except that belt tension control system 220 is specifically illustrated as comprising a mechanical linkage 234 operably coupled between belt engagers 30, 32 to automatically bi-directionally transmit movement or motion, without intervening electronics, between belt engager 30, 32. Those remaining components of system 220 which correspond to components of system 20 are numbered similarly.

As schematically illustrated in FIG. 3, mechanical linkage 234 may comprise an arrangement of one or more mechanical motion transmitting components such as springs 250, cams 252, and links/bars/cables 254. As should be appreciated, the arrangement of the springs 250, cams 252 and link/bar/cables 254 may vary depending upon the architecture of the surrounding environment in which linkage 234 is employed.

In one implementation, mechanical linkage 234 may comprise a Bowden cable having a first end operably coupled to belt engager 30 and a second end operably coupled to belt engager 32, wherein the internal cable of the Bowden cable, retained within an outer sheath, slides to transmit motion from one of belt engager 30, 32 to the other of belt engager 30, 32. In yet other implementations, other mechanical linkage components may be used in combination with the cable or independently of the cable to operably coupled belt engager 32 belt engager 32 so as to automatically transmit motion or movement bi-directionally between belt engager 30, 32, without any intervening sensors or electronics, to maintain a constant tension ratio T2/T1 within a predetermined range to reduce belt wear. In one implementation, motion is transmitted in a proportional manner such that the belt tension T2 of the second portion 48 to the belt tension T1 of the first portion 38 has a ratio of T2/T1 of at least 4 and less than or equal to 6, nominally 5. The veritable tensioning provided by system 220 maintains such a constant tension ratio T2/T1 to reduce wear of belt over time. When the belt is not running, such as during winter storage, such tension is reduced or eliminated.

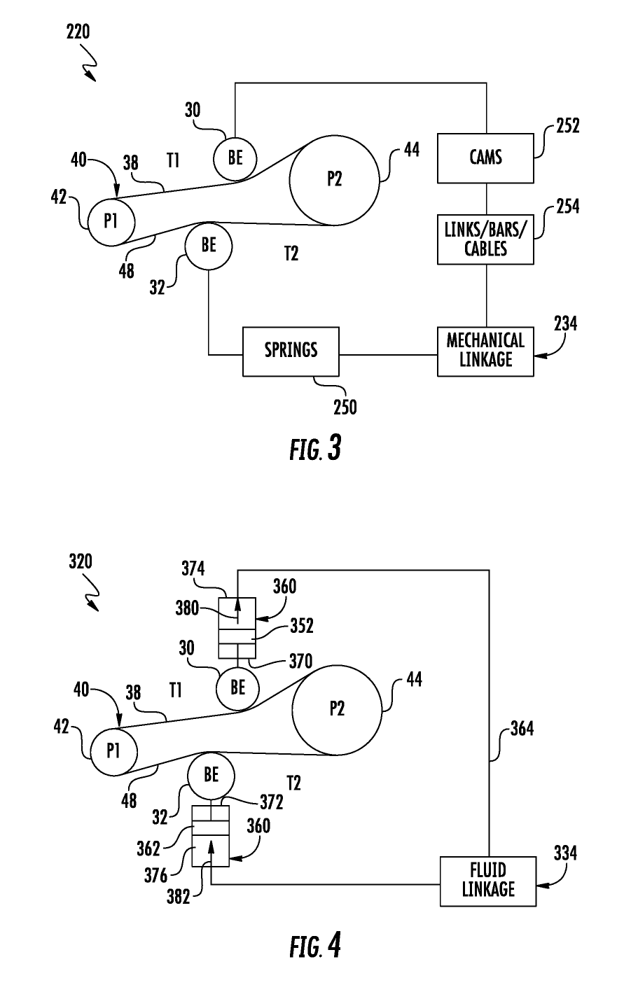

FIG. 4 schematically illustrates belt tension control system 320, an example implementation of belt tension control system 20 described above. Belt tension control system 320 is similar to system 20 except that belt tension control system 320 is specifically illustrated as comprising a fluid linkage 334 operably coupled between belt engagers 30, 32 to automatically bi-directionally transmit movement or motion, without intervening electronics, between belt engager 30, 32. Those remaining components of system 320 which correspond to components of system 20 are numbered similarly.

As schematically illustrated in FIG. 3, fluid linkage 334 comprises a fluid cylinder 350, piston 352, fluid cylinder 360, piston 362 and fluid line 364. Fluid cylinder 350 contains a fluid, such as a gas or a liquid, on either side of an internally located piston 352. Piston 352 is slidable within cylinder 350 and extends from a first side 370 of cylinder 350. Piston 352 is operably coupled to belt engager 30 so as to move with or in proportion to movement of belt engager 30.

Fluid cylinder 360 contains a fluid, such as a gas or a liquid, on either side of an internally located piston 362. Piston 362 is slidable within cylinder 360 and extends from a first side 372 of cylinder 360. Piston 362 is operably coupled to belt engager 32 so as to move with or in proportion to movement of belt engager 32.

Fluid line 364 interconnects a second side 374 of cylinder 350 to a second side 376 of cylinder 360. As a result, movement of belt engager 30 in a direction away from portion 38 of belt 40 is transmitted to piston 352 to move piston 352 in the direction indicated by arrow 380. As a result, the fluid in the second side 374 of cylinder 350 is driven out of cylinder 350, across fluid line 364 and into second side 376 of cylinder 360. The inflow of fluid into second side 376 of cylinder 360 moves piston 362 in the direction indicated by arrow 382. The movement of piston 362 in the direction indicated by arrow 382 further results in belt engager 32 being driven further towards and against portion 48 of belt 40.

Likewise, movement of belt engager 32 in a direction away from portion 48 of belt 40 is transmitted to piston 362 to move piston 362 in a direction opposite to that of arrow 382. As a result, the fluid in the second side 376 of cylinder 360 is driven out of cylinder 360, across fluid line 364 and into second side 374 of cylinder 340. The inflow of fluid into second side 374 of cylinder 350 moves piston 352 in a direction opposite to that of arrow 380. The movement of piston 352 in the direction opposite to that of arrow 380 further results in belt engager 30 being driven further towards and against portion 38 of belt 40.

In one implementation, the constant tension ratio is provided by appropriately proportioning of fluid linkage 334 such that movement of belt engager 30 in a direction away from portion 38 of belt 40 by first distance X results in belt engager 32 being moved in a direction towards portion 48 of belt 40 by second distance Y times that of the first distance, wherein Y may be greater than or less than 1. In one implementation, such proportioning may be the result of the different relative sizes of the internal volumes of cylinders 350 and 360. For example, the interior volume of cylinder 360 be smaller than the interior volume of cylinder 350 such that displacement of piston 352 by distance X due to incoming or outgoing fluid results in a displacement of piston 362 by distance Y due to the same incoming or outgoing fluid.

In other implementations, the constant tension ratio may be provided by differently configuring the connection between distance 352, 362 and belt engager 30, 32. For example, even though both distance 352, 362 may move the same distance in response to incoming or outgoing fluid, belt engager 30 may be coupled to piston 352 so as to move a first distance X given movement of piston 352 by predefined distance, wherein belt engager 32 may be coupled to piston 362 so as to move a different distance Y, in response to movement of piston 362 by the same predefined distance. For example, belt engager 32 may pivot towards and away from portion 48, wherein a sufficiently long lever arm operably coupled between piston 362 and belt engager 32 provides the aforementioned distance multiplication or division.

In one implementation, motion is transmitted in a proportional manner such that the belt tension T2 of the second portion 48 to the belt tension T1 of the first portion 38 has a ratio of T2/T1 of at least 4 and less than or equal to 6, nominally 5. The veritable tensioning provided by system 320 maintains such a constant tension ratio T2/T1 to reduce wear of belt over time. When the belt is not running, such as during winter storage, such tension is reduced or eliminated.

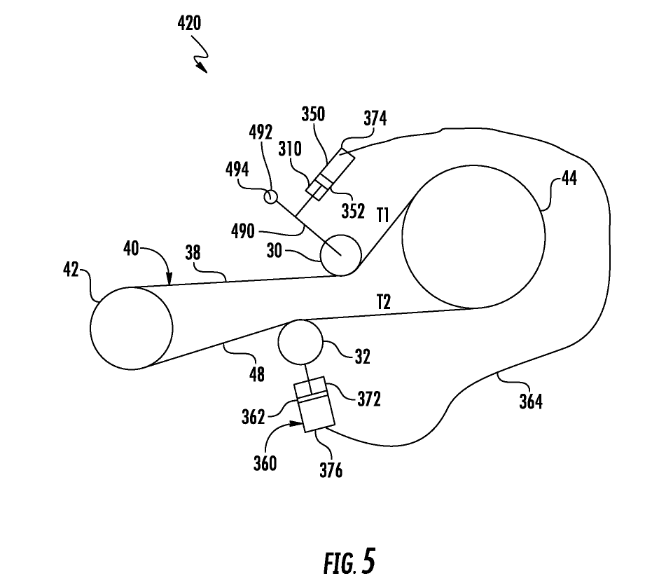

FIG. 5 schematically illustrates belt tension control system 420, another example implementation of belt tension control system 20. Belt tension control system 420 is similar to belt tension control system 320 except that belt tension control system 420 is specifically illustrated as comprising swing arm 490. The remaining components of belt tension control system 420 which correspond to components of belt tension control system 320 are numbered similarly.

Swing arm 490 operably couples piston 352 to belt engager 30. Swing arm 490 has a first end coupled to belt engager 30 and a second and 492 which pivots about an axis 494. And intermediate portion of swing arms 494 is operably connected to piston 352. Movement of piston 352 swing swing arm 490 about axis 494 so as to move belt engager 30 towards or away from portion 38 of belt 40. Swing arms 490 proportions the distance by which belt engager 30 moves against portion 38 with respect to the distance by which piston 352 is moved within cylinder 350 as a result of incoming or outgoing fluid. Although not illustrated, in other implementations, belt engager 32 may likewise be movably supported by swing arm similar to swing arms 490, wherein the swing arm has an intermediate portion operably coupled to piston 362.

In one implementation, motion is transmitted in a proportional manner such that the belt tension T2 of the second portion 48 to the belt tension T1 of the first portion 38 has a ratio of T2/T1 of at least 4 and less than or equal to 6, nominally 5. The veritable tensioning provided by system 420 such a constant tension ratio T2/T1 to reduce wear of belt over time. When the belt is not running, such as during winter storage, such tension is reduced or eliminated.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements.

What is claimed is:

1. A belt tension control system comprising:
a first belt engager to engage a first portion of a belt extending between and on a first side of first and second pulleys, the first belt engager being movably supported so as to move in response to changes in tension of the first portion of the belt;
a second belt engager to engage a second portion of the belt extending between and on a second side of the first and second pulleys, the second belt engager being movably supported so as to move in response to changes in tension of the second portion of the belt; and
a linkage connecting the first belt engager to the second belt engager such that movement of the first belt engager towards the first portion of the belt automatically retracts the second belt engager away from the second portion of the belt, wherein the linkage automatically maintains a constant ratio of belt tension of the first portion to belt tension of the second portion.

2. The belt tension control system of claim 1, wherein the linkage comprises a mechanical linkage.

3. The belt tension control system of claim 1, wherein the linkage comprises a fluid linkage.

4. The belt tension control system of claim 1, wherein the linkage comprises:
a first fluid cylinder;
a first piston slidably disposed within the first fluid cylinder and extending from a first side of the first fluid cylinder, wherein the first belt engager is connected to the first piston;
a second fluid cylinder;
a second piston slidably disposed within the second fluid cylinder and extending from a first side of the second fluid cylinder, wherein the second belt engager is connected to the second piston; and
a fluid line connecting a second side of the first fluid cylinder to a second side of the second fluid cylinder such that the first portion of the belt and the second portion of the belt are automatically maintained at a constant tension ratio.

5. The belt tension control system of claim 4, wherein the constant ratio is between 4 and 6.

6. The belt tension control system of claim 5, wherein the constant ratio is 5.

7. The belt tension control system of claim 1, wherein the constant ratio is between 4 and 6.

8. The belt tension control system of claim 7, wherein the constant ratio is 5.

9. The belt tension control system of claim 1 further comprising the first and second pulleys and the belt wrapped about the first and second pulleys.

10. A belt tension control system comprising:
a first fluid cylinder;
a first piston slidably disposed within the first fluid cylinder and extending from a first side of the first fluid cylinder;
a first belt engager connected to the first piston and to engage a first portion of a belt extending between and on a first side of first and second pulleys;
a second fluid cylinder;
a second piston slidably disposed within the second fluid cylinder and extending from a first side of the second fluid cylinder;
a second belt engager connected to the second piston and to engage a second portion of a belt extending between and on a second side of the first and second pulleys; and
a fluid line connecting a second side of the first fluid cylinder to a second side of the second fluid cylinder such that the first portion of the belt and the second portion of the belt are automatically maintained at a constant tension ratio.

11. The belt tension control system of claim 10 further comprising the first and second pulleys in the belt wrapped about the first and second pulleys.

12. The belt tension control system of claim 10, wherein the constant ratio is between 4 and 6.

13. The belt tension control system of claim 12, wherein the constant ratio is 5.

14. A method comprising:
engaging a first portion of an endless belt wrapped about first and second pulleys with a first belt engager;
engaging a second portion of an endless belt wrapped about the first and second pulleys with a second belt engager operably linked to the first belt engager; and
transmitting motion of the first belt engager to the second belt engager such that movement of the first belt engager away from the first portion of the belt automatically moves the second belt engager towards the second portion of the belt to maintain a constant ratio of belt tension of the first portion to belt tension of the second portion.

15. The method of claim 14, wherein the motion is transmitted by a mechanical linkage interconnecting the first belt engager and the second belt engager.

16. The method of claim 14, wherein the motion is transmitted by a fluid linkage interconnecting the first belt engager and the second belt engager.

17. The method of claim 14, wherein the motion is transmitted by:
transmitting motion of the first belt engager to a first piston within a first fluid cylinder to move fluid in a fluid line so as to move a second piston within a second fluid cylinder; and
transmitting motion of the second piston to the second belt engager.

18. The method of claim 17, wherein moving the second belt engager comprises pivoting the second belt engager.

19. The method of claim 14, wherein the constant ratio is between 4 and 6.

20. The method of claim 19, wherein the constant ratio is 5.
